(19) United States
(12) Patent Application Publication
(10) Pub. No.: US 2006/0033750 A1
(43) Pub. Date: Feb. 16, 2006

(54) Method of primitive distribution and stroke rendering

(76) Inventor: Chun-Yi Wang, Taipei (TW)

Correspondence Address: BIRCH STEWART KOLASCH & BIRCH, PO BOX 747, FALLS CHURCH, VA, 22040-0747, US

(21) Appl. No.: 10/915,379

(22) Filed: Aug. 11, 2004

(51) Int. Cl. G09G 5/00

(52) U.S. Cl. 345/616

(57) ABSTRACT

A method of primitive distribution and stroke rendering. First, a source image and primitives thereof are obtained. Brightness and contrast values of the source image are obtained and adjusted. Drawing points of the source image are generated using an Error Diffusion Method. Finally, the primitives are rendered at the drawing points, thereby outputting a resulting image.

The present invention relates to a data processing method, and in particular to a method of primitive distribution and stroke rendering.

Digital image technologies have been common used in image editing, comprising adding 2D or 3D special effects to image files that the special effects include pointillism. An image converted using stipple drawing includes a mass of points with different sizes, and is vivid with well-distributed points.

A well-know method for generating well-distributed points is by placing points roughly using a half-toning algorithm on an input image and then relaxing those points using a relaxation algorithm until they are well-spaced, as disclosed by Oliver Deussen and et al., “Floating Points: A Method for Computing Stipple Drawings,” Computer Graphics Forum 19, 3 (August), 2000. A major drawback of this method is the long rendering time. In order to achieve the goal of well-spaced points, iterations of the relaxation step are executed repeatedly to acquire better quality images. Thus, it might take up to eight hours to relax 60,000 points evenly. This method is also designed for interactive use with an artist, thus, an input image needs to be segmented in order to preserve the degree of detail desired.

A more efficient relaxation algorithm is used for modification of the disclosed method, by Oliver Deussen and et al, to reduce rendering time and preserve image details at the same time, without user interaction, as disclosed by Adrian Secord, “Weighted Voronoi Stippling,” NPAR 2002. The rendering speed is dramatically improved, but it still takes up to 20 minutes to render 40,000 points.

An image also can be converted using Pen-and-Ink drawing. For Pen-and-Ink drawing reproduction, a pen-and-ink drawing is generated from image or 3D scene using a disclosed method by Adrian Secord and et al.,“Fast Primitive Distribution for Illustration,” 13^{th} Eurographics Workshop on Rendering, 2002. They first derive a probability density function (PDF) from the input image, and a sequence of precomputed and uniformly distributed points in 2D is then redistributed according to the PDF. Those points are then used to place primitives, and different drawing styles can be achieved by varying the primitive type or direction.

As summarized above, conventional methods are inefficient with spending too much rendering time. In addition, a simple method that can generate much better quality images is required. Thus, an effective and simple method to achieve the described goals is desirable.

### SUMMARY

Accordingly, an object of the present invention is to provide a method of primitive distribution and stroke rendering, generating well-distributed drawing points for high quality images and preserving tone and high frequency detail of an input image.

According to the object described, an embodiment of the invention provides a method of primitive distribution and stroke rendering. First, a source image and primitives thereof are obtained. The source image is converted to a grayscale image, the brightness and contrast are obtained, and brightness and contrast of the source image are adjusted. Next, drawing points of the source image are generated using an Error Diffusion Method. Finally, the primitives are rendered at the drawing points, thereby outputting a resulting image

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a flowchart showing the method of primitive distribution and stroke rendering according to an embodiment of the invention;

FIG. 2 is a flowchart showing the method of generating drawing points according to an embodiment of the invention;

FIG. 3 is a schematic diagram of a stippling drawing of an embodiment of the invention, in which the color of the drawing is plain black-and-white;

FIG. 4 is a schematic diagram of a stippling drawing of an embodiment of the invention, in which the drawing is painted by pixel colors of the source image;

FIG. 5 is a schematic diagram of a pen-and-ink cross-hatching drawing of an embodiment of the invention, in which the color of the drawing is plain black-and-white; and

FIG. 6 is a schematic diagram of a pen-and-ink cross-hatching drawing of an embodiment of the invention, in which the drawing is painted by pixel colors of the source image.

### DETAILED DESCRIPTION

The present invention discloses a method of primitive distribution and stroke rendering.

The invention uses an effective and simple method to generate well-distributed points, producing higher quality images, while the resulting drawing reproduction preserves original tones and details, in which the method is disclosed by Victor Ostromoukhov, “A Simple and Efficient Error-Diffusion Algorithm,” SIGGRAPH 2001.

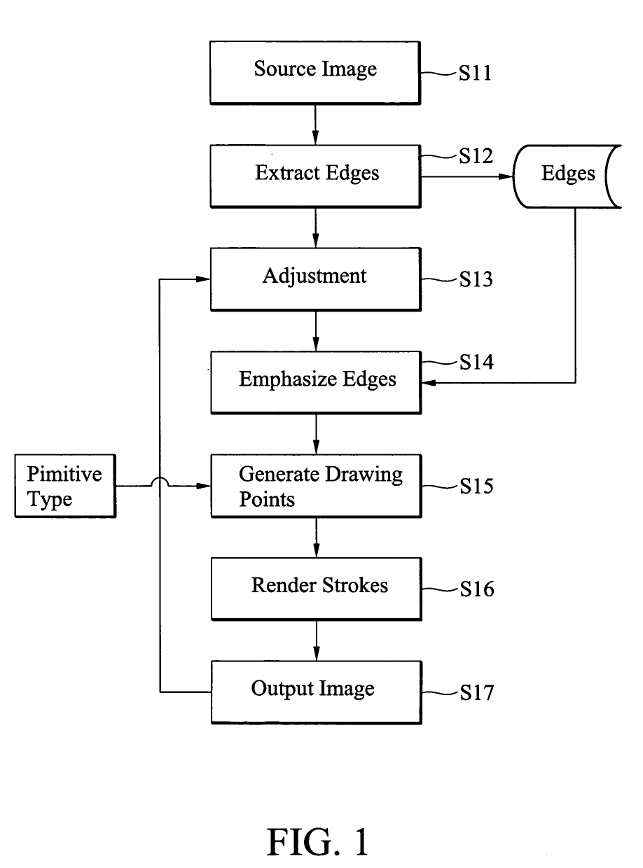

FIG. 1 is a flowchart showing the method of primitive distribution and stroke rendering according to an embodiment of the invention.

In step S11, a source image and primitives corresponding to the source image are acquired. The primitives can be either system predefined or user input. A primitive, in computer graphics, is a basic element, such as a line or an arc, or, in the invention, is a stipple or a pen stroke. The primitive used to create images also can be texture or any other rendered object in other applications.

In step S12, edges of the source image is extracted using a Canny algorithm to preserve high-frequency details and edges thereof, and the edges are stored in a buffer.

In step S13, the source image is converted to a grayscale image for adjustment of the brightness and contrast, obtaining values of the image parameters for generating a more convincing stipple drawing. The adjustment can be performed either automatically by the system or manually by users. In addition, the source image can be also converted to other format images.

In step S14, the edges of the adjusted image are emphasized using the extracted edges stored in the buffer, decreasing grayscale values of edge pixels.

In step S15, well-distributed drawing points are generated using a halftoning method, named Modified Error Diffusion Method disclosed by Victor Ostromoukhov. The drawing points represent locations of the primitives on the source image.

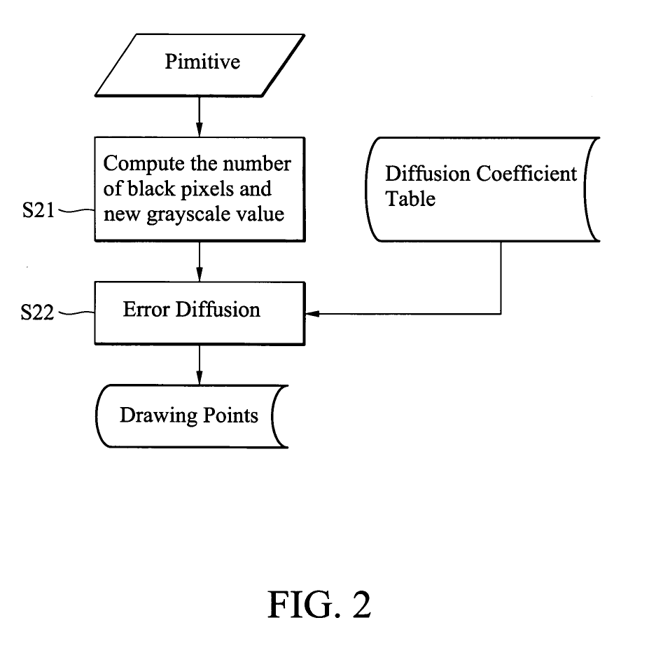

The generating step further comprises the steps described in the following, as shown in FIG. 2.

Well-distributed drawing points for stipple are generated using the Modified Error Diffusion Method, which utilizes an Error Diffusion Coefficient Table. Primitive density is inversely proportional to a grayscale value of the source image, decreased in order to achieve the same target grayscale value when the size of a primitive increases. Thus, the number of black pixels corresponding to a stipple image among the drawing points is first computed, and then a new grayscale value corresponding to the number of black pixels is obtained for looking up three coefficients corresponding to the stipple image (step S21), used in the Error-Diffusion process.

In the following is a computation process for black pixels and corresponding grayscale value of a stipple image. A number of black pixels of a stipple image used is computed using the following equation:
nNumBlack=nCellSize*(255−elementGray)/255,
where nNumBlack is the number of black pixels, nCellSize is the size of the stipple image, and elementGray is the average grayscale value of the stipple image. Next, a new grayscale value corresponding to the number of the black pixels is obtained, using the following equation for looking up three coefficients:
newGray=255−min((255−sourcegray)/nNumBlack, 255),
where newGray is a new grayscale value corresponding to a source pixel to be processed, and sourceGray is the original grayscale value of the source pixel. The newGray value used in Error-Diffusion Process looks up three coefficients in an Error Diffusion Coefficient Table (step S22). By using the computed new grayscale value achieves desired global tone for input primitives.

Drawing points are thus generated by Error Diffusion Method.

In step S16, after the points are generated, the primitives are rendered at the drawing points, and the rendered image is enhanced by the brightness and contrast values. Various drawing styles can be achieved by using different primitive types and rendering styles. The drawing points, for example, are rendered by dots, for generating stipple drawings, and by hatch strokes with a specific rendering method, for generating pen-and-ink drawings.

The rendered color on primitives is plain black-and-white, user-defined single color, or source pixel color. Moreover, the primitives can be rendered directly on the output image, or in a mask buffer to create special drawing styles.

In step S17, the processed image is output.

In the following describes a stipple drawing and a pen-and-ink drawing of embodiments of the invention.

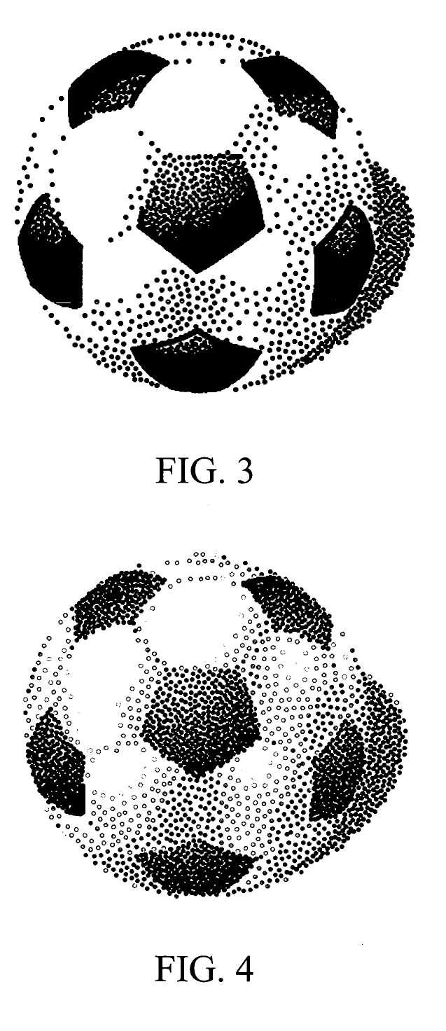

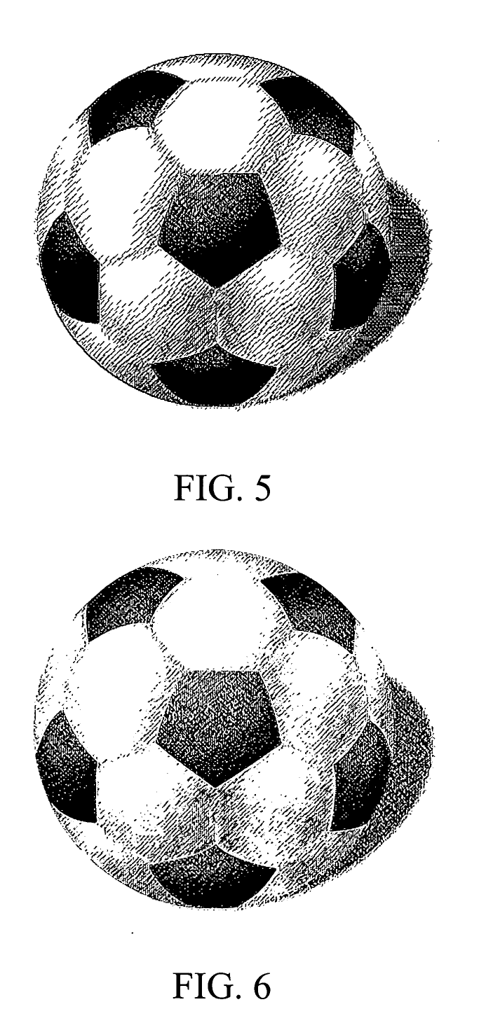

First, a source image is first input and primitives thereof are acquired. Primitives for the stippling drawing can be one-size, or various sizes for different grayscale ranges. A dot, for example, of five pixels is input and used as the only stroke for the whole image, as shown in FIG. 3, in which the color of the pixels is plain black-and-white, and FIG. 4, in which the drawing is painted by pixel colors of the source image. Alternatively, three dots of 1 pixel, 3 pixels, and 5 pixels are input and each is used for different grayscale ranges (not shown). On the other hand, different styles of pen-and-ink drawings are generated using different primitive types. A short line primitive, for example, forms a hatching style drawing, while combination of different angles of short line primitives generates a cross-hatching style drawing, as shown in FIG. 5, in which the color of the pixels is plain black-and-white, and FIG. 6, in which the drawing is painted by pixel colors of the source image.

Next, edges of the source image are extracted. The source image is then converted to a grayscale image for extraction of brightness and contrast. Adjustment for the grayscale image is executed, and the edges of the adjusted image are emphasized using the extracted edges. Drawing points corresponding to the primitive locations are generated and the generating steps are identical with the steps described in FIG. 2.

Next, for the stipple drawing, the primitives are rendered directly at the drawing points, with enhanced by the values of the brightness and contrast. For the pen-and-ink drawing, the primitives are rendered at the drawing points. Several predefined or user-input primitives with different angles are used for image generation in cross-hatching style. The cross-hatching appearance can be achieved by rendering different angles of primitive at the drawing points. Suppose there are three angles of primitives, for example, named P1, P2, and P3 (not shown), and the grayscale (0 to 255) is segmented into three segments, comprising S1 (0 to 80), S2 (81 to 160), and S3 (161 to 255) (not shown). Only P3 is used for rendering a drawing point with desired target grayscale rendering within S3, P2 and P3 are used for target grayscale rendering within S2, each including individual corresponding probability, and P1, P2, and P3 are used for target grayscale rendering within S1, each including individual corresponding probability.

The cross-hatching appearance is generated with little effort by using the method of an embodiment of the invention. In order to preserve edge details of the source image, constraints are allowed while rendering primitives at drawing points on edges, for example, by insuring primitives without crossing edges to create more convincing results. Finally, the resulting image is output.

Embodiments of the invention provide a simple and efficient method, generating well-distributed drawing points for stipple or pen-and-ink drawings and achieving global tone after placing primitives at the drawing points, and are applied to digital image/video processing. Embodiments of the invention further take system-predefined or user-input strokes as primitives to be rendered at the drawing points and preserve both tone and high-frequency details.

While embodiments of the invention have been described by way of example and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

what is claimed is:

1. A method of primitive distribution and stroke rendering, comprising the steps of:
obtaining a source image and primitives thereof;
adjusting brightness and contrast of the source image;
generating drawing points of the source image according to the primitives; and
rendering the primitives at the drawing points, thereby outputting a resulting image.

2. The method as claimed in claim 1, wherein image adjustment further comprises the steps of:
converting the source image to a grayscale image; and
obtaining the brightness and contrast values.

3. The method as claimed in claim 2, wherein the primitives are system-defined or user input.

4. The method as claimed in claim 1, wherein the point generation further comprises the steps of:
computing the number of black pixels of one source pixel;
obtaining a grayscale value of the source pixel corresponding to the number of the black pixels; and
looking up coefficients corresponding to the source pixel according to the grayscale value.

5. The method as claimed in claim 4, wherein the point generation is implemented using an Error Diffusion Method.

6. The method as claimed in claim 4, wherein a rendered color on the primitives is plain black-and-white, user-defined single color, or source pixel color.

7. The method as claimed in claim 1, further comprising the step of extracting edges of the source image.

8. The method as claimed in claim 7, wherein edges of the resulting image are further enhanced using the extracted edges.

9. A storage medium for storing a computer program providing a method of primitive distribution and stroke rendering, comprising using a computer to perform the steps of:
obtaining a source image and primitives thereof;
adjusting brightness and contrast of the source image;
generating drawing points of the source image according to the primitives; and
rendering the primitives at the drawing points, thereby outputting a resulting image.

10. The storage medium as claimed in claim 9, wherein image adjustment further comprises the steps of:
converting the source image to a grayscale image; and
obtaining the brightness and contrast values.

11. The storage medium as claimed in claim 10, wherein the primitives are system-defined or user input.

12. The storage medium as claimed in claim 9, wherein the point generation further comprises the steps of:
computing the number of black pixels of one source pixel;
obtaining a grayscale value of the source pixel corresponding to the number of the black pixels; and
looking up coefficients corresponding to the source pixel according to the grayscale value.

13. The storage medium as claimed in claim 12, wherein the point generation is implemented using an Error Diffusion Method.

14. The storage medium as claimed in claim 12, wherein a rendered color on the primitives is plain black-and-white, user-defined single color, or source pixel color.

15. The storage medium as claimed in claim 9, further comprising the step of extracting edges of the source image.

16. The storage medium as claimed in claim 15, wherein edges of the resulting image are further enhanced using the extracted edges.
